(19) United States
(12) Patent Application Publication
(10) Pub. No.: US 2008/0157961 A1
(43) Pub. Date: Jul. 3, 2008

(54) System, method and medium tracking action history of user

(75) Inventors: Tae-suh Park, Yongin-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/882,101

(22) Filed: Jul. 30, 2007

(30) Foreign Application Priority Data
Jan. 3, 2007 (KR) 10-2007-0000796

(51) Int. Cl. G08B 21/00

(52) U.S. Cl. 340/540

(57) ABSTRACT

A system, method and medium tracking an action history of a user by recognizing a user's actions as predetermined indicator actions that might cause lost items, storing the user's locations whenever the indicator actions are recognized, and storing the recognized indicator actions as an action history of user to supply the user with information on the stored action history, thereby allowing the user to easily find the lost items. The system includes a location sensor to sense a location of a user, an action sensor to sense an action of the user, an action-recognition unit to recognize the sensed action as a predetermined indicator action, an action-history storage unit to store the sensed location and the recognized indicator action as the action history of the user, and an information-supply unit to supply the user with the stored action history upon request.

### CROSS-REFERENCE TO RELATED APPLICATIONS

This application claims priority from Korean Patent Application No. 10-2007-0000796 filed on Jan. 3, 2007 in the Korean Intellectual Property Office, the disclosure of which is incorporated herein by reference in its entirety.

### BACKGROUND

1. Field

One or more embodiments of the present invention relate to a system, method and medium tracking an action history of a user. More particularly, one or more embodiments of the present invention relate to a system, method and medium tracking an action history of a user by recognizing user actions as predetermined indicator actions that might cause lost items, storing detected user's locations whenever the indicator actions are recognized, and storing the recognized indicator actions as an action history of a user to supply the user with information thereby allowing the user to easily find the lost items.

2. Description of the Related Art

It is not uncommon for people to leave their bags or wallets behind in a subway or a bus. Items may even sometimes be misplaced within a person's house. Such events are stressful and sometimes financially damaging.

This is especially a problem for the elderly because, in many cases, impaired memory may accompany aging, hampering their daily lives. In an aging society, losing items frequently results in not only individual inconvenience but increased costs to society.

To address such problems, various techniques for tracking lost items have been proposed. Conventional techniques include attaching a wireless transmitter or a radio frequency (RF) ID tag to an item to be monitored and ringing an alarm when the distance between the item and a user exceeds a predetermined level, and a technique of tracking a location where the item was lost using a wireless receiver or a separately installed RF ID reader.

In conventional tracking techniques, however, it is necessary to attach a wireless transmitter to every item that may be lost, which is impractical. In addition, since one wireless transmitter is required for each item to be monitored, increased cost is inevitable.

### SUMMARY

One or more embodiments of the present invention provide a system, method and medium tracking an action history of a user by mounting a device capable of sensing an action of the user on appropriate parts of the user's body, recognizing the sensed action as a predetermined indicator action, storing the recognized indicator action and a location where the indicator action has been sensed, and supplying the user with information on the stored action history upon request thereby allowing the user to easily track her action history to find the lost items.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a system for tracking an action history of a user, including, a location sensor to sense a location of a user, an action sensor to sense an action of the user, an action-recognition unit to recognize the sensed action as a predetermined indicator action, an action-history storage unit to store the sensed location and the recognized indicator action as the action history of the user, and an information-supply unit to supply the user with the stored action history upon request.

To achieve at least the above and/or other aspects and advantages, embodiments of the present invention include a method for tracking an action history of a user, the method including, sensing a location of a user, sensing an action of the user, recognizing the sensed action as a predetermined indicator action, storing the sensed location and the recognized indicator action as the action history of the user, and supplying the user with the stored action history upon request.

To achieve at least the above and/or other aspects and advantages, embodiments of the present invention include a method tracking actions of a user, the method including, sensing an action of the user, recognizing the sensed action as a predetermined indicator action, storing the recognized indicator action along with a corresponding location and time as an action history of the user, and providing the stored action history upon request.

To achieve at least the above and/or other aspects and advantages, embodiments of the present invention include a system tracking actions of a user, the system including, an action sensor to sense an action of the user, an action-recognition unit to recognize the sensed action as a predetermined indicator action, an action-history storage unit to store the recognized indicator action along with a corresponding location and time as an action history of the user, and an information-supply unit to provide the stored action history upon request.

### BRIEF DESCRIPTION OF THE DRAWINGS

These and/or other aspects and advantages of the invention will become apparent and more readily appreciated from the following description of embodiments, taken in conjunction with the accompanying drawings of which:

FIG. 1 illustrates a system tracking an action history of a user, according to an embodiment of the present invention;

FIGS. 2-4 illustrate a graphical user interface, according to an embodiment of the present invention;

FIG. 5 illustrates an action-history storage system mounted on a predetermined part of a user's body, according to an embodiment of the present invention;

FIG. 6 illustrates a method of storing an action history of a user, according to an embodiment of the present invention; and

FIG. 7 illustrates a method of supplying a user with the stored action history, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

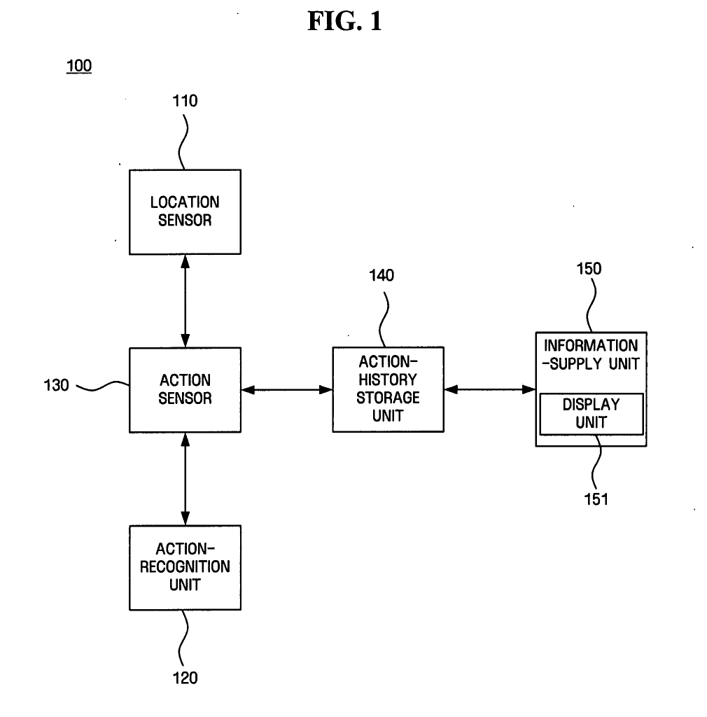

FIG. 1 illustrates a system tracking an action history of a user, according to an embodiment of the present invention.

As shown in FIG. 1, the tracking system 100 may include, for example, a location sensor 110 sensing a location of a user, an action sensor 120 sensing an action of the user, an action-recognition unit 130 recognizing the sensed action as a predetermined indicator action, an action-history storage unit 140 storing the sensed location and the recognized indicator action as the action history of the user, and an information-supply unit 150 supplying the user with the stored action history upon request.

The location sensor 110 may sense the user's location using known indoor and outdoor locating techniques, such as GPS (Global Positioning System), indoor GPS, and the like. In addition, the location sensor 110 may sense the user's location at a predetermined time interval or when the user's action is recognized as a predetermined indicator action, but is not limited thereto. While the location sensor 110 may sense the user's action when the user's action is recognized as a predetermined indicator action in an illustrated embodiment of the present invention, the invention is not limited thereto, and other ways of sensing may be used.

In detail, the location sensor 110 may sense the user's location indoors and outdoors. In addition, in order to more specifically sense the user's location, the location sensor 110 may refer to indoor and outdoor maps incorporated therein, or a map stored in an external system through a network.

The action sensor 120 may sense the user's action using a variety of sensors mounted on one or more predetermined parts of a user's body. In detail, the action sensor 120 may sense the user's action using one or more of an inertial sensor, a pressure sensor, an electromyogram sensor, a pulse sensor or the like. Such a sensor may be mounted on a predetermined part of a user body to measure movement, pulse or similar user activities.

For example, the inertial sensor may be mounted on a user's waist or wrist to sense physical movement, e.g., walking or colliding with another person. The pressure sensor or the electromyogram sensor may be mounted on the user's wrist to sense the user's hand action, e.g., grasping or letting go. For example, Kanasugi et al. teaches technology of sensing specific predetermined actions from signals supplied from an inertial sensor worn by a user in an article “Measurement of Human Action and Identification of Activity Modes by Wearable Sensors,” The 24th Asian Conference on Remote Sensing.

The user's actions, as may be sensed by the action sensor 120 using measurement results of such various sensors, will now be described by way of example.

The action sensor 120 may sense a user's actions, e.g., colliding with another or falling down, according to the measurement results. The action sensor 120 may also sense user's activities, e.g., dozing, through movement of a user's eyes, alpha waves, pulse, breathing rate, or the like. As additional examples, the action sensor 120 may sense an action of grasping based on the result of measuring electromyogram signals from the user's arm, and an action of sitting based on the result of measuring relative positions, movement and pressures of legs and arms. Further, the action sensor 120 may sense an action of running based on the result of measuring relative positions, movement of legs and arms and heart rate. In addition, the action sensor 120 may sense hurrying by the user based on the result of measuring alpha waves, pulse, and adrenalin levels. Of course, the examples of actions sensed by the action sensor 120 are provided only for a better understanding of one or more embodiments of the present invention, and the invention is not limited thereto.

The action-recognition unit 130 may recognize the user's actions as sensed by the action sensor 120 as a predetermined indicator action. Here, the predetermined indicator action may refer to an action easily causing a particular result among a variety of user's actions routinely occurring in the daily life of the user. For example, at the moment when the user gets out of a car, the user may be likely to drop a purse or a key ring from a pocket. When the user leaves a restaurant after finishing a meal, the user may be apt to leave her umbrella or bag. Based on such experiences, actions of “standing to get out of the car” or “standing suddenly” may be defined as indicator actions that may signal the event of losing an item.

In addition and by way of example, the present invention will be described with reference to one or more embodiments, in which the indicator action recognized by the action-recognition unit 130 may be an action easily resulting in the loss of an item. The action-recognition unit 130 may recognize the action sensed by the action sensor 120 as an indicator action easily resulting in the loss of an item.

Here, examples of the indicator action may include, but are not limited to, colliding, collapsing, dozing, grasping, sitting, reclining, standing, running and hurrying, for example.

The action-history storage unit 140 may store the sensed location and the recognized indicator action as an action history of the user. In addition, the action history stored in the action-history storage unit 140, may include, but is not limited to, a time at which the indicator action has been recognized, the sensed location and the recognized indicator action. Here, the action history stored in the action-history storage unit 140 may be stored in any time unit such as hours, months or years. After a predetermined time has elapsed, a previously stored action history may be deleted.

Upon request, the information-supply unit 150 may supply the user with the actions stored in predetermined time units or a point in time at which the indicator action has occurred, based on the action history stored in the action-history storage unit 140.

The information-supply unit 150 may supply the user with the action history in a text format or by way of a predetermined graphical user interface. In an illustrated embodiment of the present invention, the information-supply unit 150 may supply the user with the action history information through a predetermined graphical user interface. Of course, even when the information-supply unit 150 supplies the user with information on the action history in text format, the information in the action history may be identical to the information supplied by way of a graphical user interface.

The graphical user interface used when the information-supply unit 150 supplies the user with the action history may have a predetermined map that may include, for example, a movement track, an indicator action, a location where the indicator action has been recognized, and a time at which the indicator action has been recognized. Thus, the user may be able to jog her memory regarding a particular moment and location at which an item was lost, while tracking back or retracing the action history supplied from the information-supply unit 150. In addition, the user may be able to limit the tracking scope, e.g., to a particular time or location.

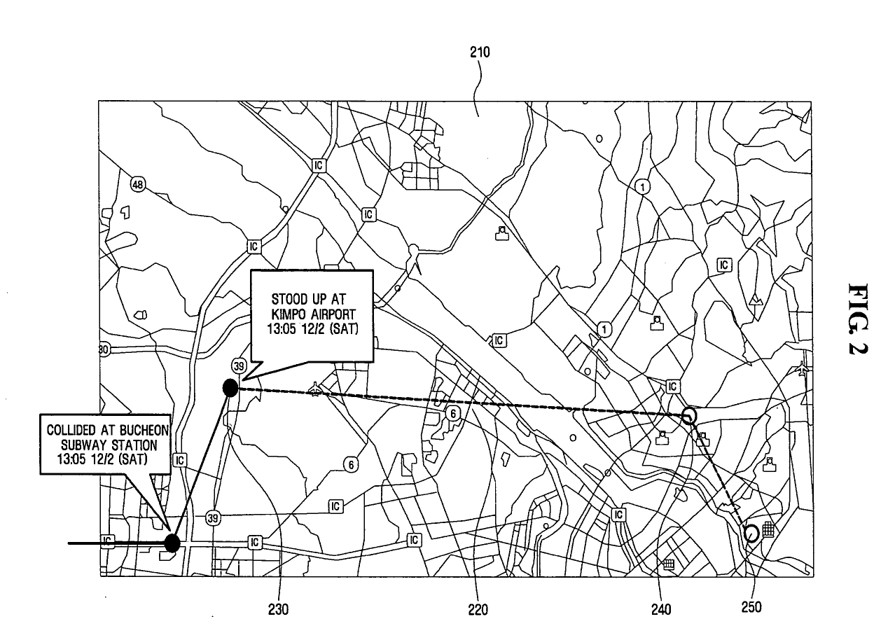

FIGS. 2 through 4 illustrate a graphical user interface, according to an embodiment of the present invention.

As shown in FIG. 2, the graphical user interface 200 may include, for example, a movement track 220 of the user, and a plurality of symbols 230, 240, 250 indicating indicator actions recognized by the action-recognition unit 130 and displayed on a predetermined map 210.

For example, if the user took her purse out of her pocket to make a purchase at a store in the Kimpo Airport terminal yesterday, the user may sequentially retrace and review past actions, e.g., actions leading to the event of losing the purse. The review may be limited to a predetermined period of time based on the time when the user went to the Kimpo Airport terminal, using the action history supplied from the information-supply unit 150, thereby assisting the user to recall where she last put the purse.

Referring to FIG. 2, for the example in which the user sets Kimpo Airport 230 as a tracking location in the action history supplied from the information-supply unit 150, a map coverage range may be adjusted to supply the user with information on any indicator actions recognized at Kimpo Airport 230, the location at which the indicator action has been recognized, and the time at which the indicator action has been recognized.

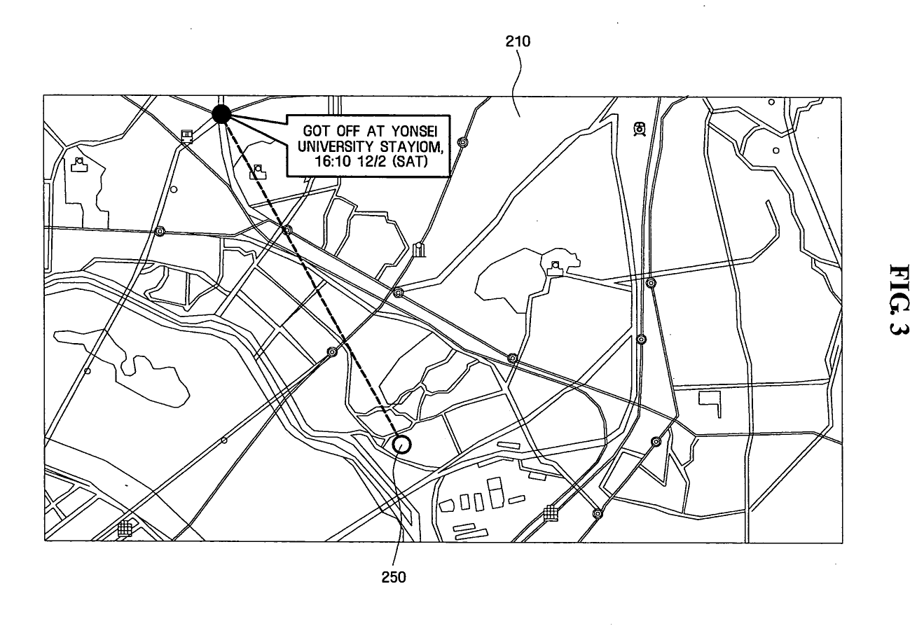

Continuing the example, when the user also sets Yonsei University 240 as a tracking location, the information-supply unit 150 may adjust the map coverage range such that Yonsei University 240, where the indicator action has been recognized, as well as Kimpo Airport 230, may be viewed, as shown in FIG. 3. While a movement track 220 between Kimpo Airport 230 and Yonsei University 240 may be illustrated as marked on the maps shown in FIGS. 2 and 3, such movement tracks are provided only for better illustration of embodiments of the present invention. Alternatively, the marking of the movement track 220 on the maps may be omitted or the movement track 220 need not be identical with an actual movement track, e.g., different scales may be used for portions of the movement track. Referring to FIGS. 2 and 3, a path between the locations that have already been retraced by the user is indicated by a solid line, thereby allowing the user to easily identify locations for which tracking has already been made.

In addition, the user may shift tracking locations according to a sequence of time or a reverse sequence thereof. The shifting of the tracking locations may be performed by entering a predetermined function key, for example. Here, the key may take a variety of types as long as it can shift a direction, including a button, touch pad, joystick, and so on.

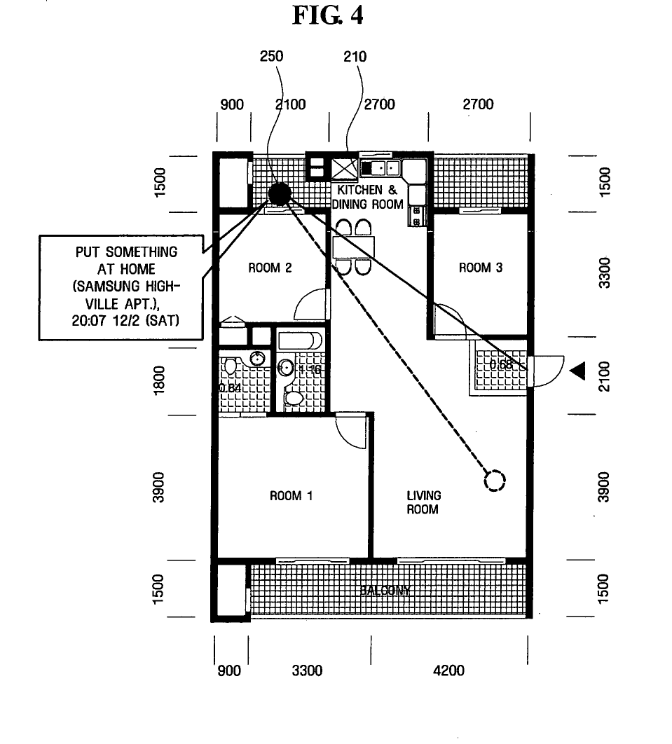

Meanwhile, where a distance between locations at which indicator actions have been recognized is small, for example, indoors, a map may be adjustably varied to display the locations, e.g., the scale may be changed accordingly as shown in FIG. 4. In other words, where indicator actions have been recognized outdoors, as shown in FIGS. 2 and 3, an outdoor map may be used. In contrast, where indicator actions have been recognized indoors, an indoor map may be used, as shown in FIG. 4.

Referring to FIG. 4 and as an example, when seeing a message such as “put an item in a multi-purpose room 250”, the user may remember that she put her purse in a bag in the multi-purpose room 250.

Therefore, the user may retrace a location where an item was lost and a time at which the item was lost, according to at least one of the indicator actions, a location at which the indicator action has been recognized, and a time at which the indicator action has been recognized, in a sequence of time or its reverse sequence using the action history supplied from the information-supply unit 150.

In an embodiment of the present invention, various functional components of the action history tracking system 100 may be integrated in hardware or may be embodied separately from one another. For example, the location sensor 110, the action sensor 120, the action-recognition unit 130 and the action-history storage unit 140 may be mounted on a predetermined part of user's body while the information-supply unit 150 may be mounted on a portable device belonging to the user, e.g., a mobile phone.

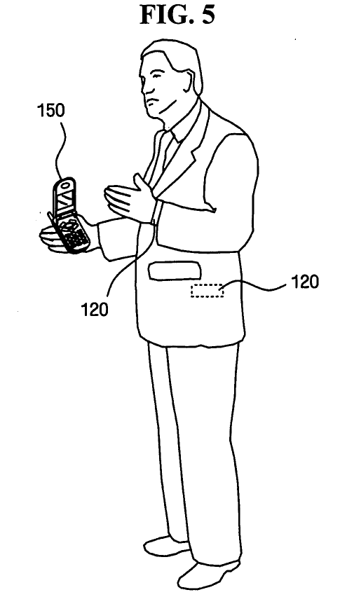

Continuing the example, where the information-supply unit 150 is mounted on a user's mobile phone, as shown in FIG. 5, the information-supply unit 150 may extract the action history of the user from the action-history storage unit 140 using short range wireless communication techniques, e.g., Bluetooth®, and the extracted action history may be supplied to the user via a graphical user interface. To this end, the information-supply unit 150 may further include a display unit 151 for displaying the extracted action history using the graphical user interface. The display unit 151 may be a liquid crystal display of a portabledevice, for example.

In addition, as shown in FIG. 5, the action sensor 120 capable of sensing the user's action may be mounted on the user, e.g., on the user's wrist or waist, and different kinds of sensors may be mounted on other parts of the user's body. FIG. 5 illustrates the action sensor 120 mounted on a main part of the user's body as only an example to enhance understanding of embodiments of the present invention. However, the location sensor 110, the action sensor 120, the action-recognition unit 130 and the action-history storage unit 140 may each be integrally mounted on any part of the user's body, or may be mounted on separate parts of the user's body in separate units, or any combination of the above.

A method of tracking the action history of the user, according to an embodiment of the present invention will now be described in detail.

The method of tracking the action history of the user, according to an embodiment of the present invention, may be divided into a method of storing the action history and a method of supplying the user with the action history, as an example.

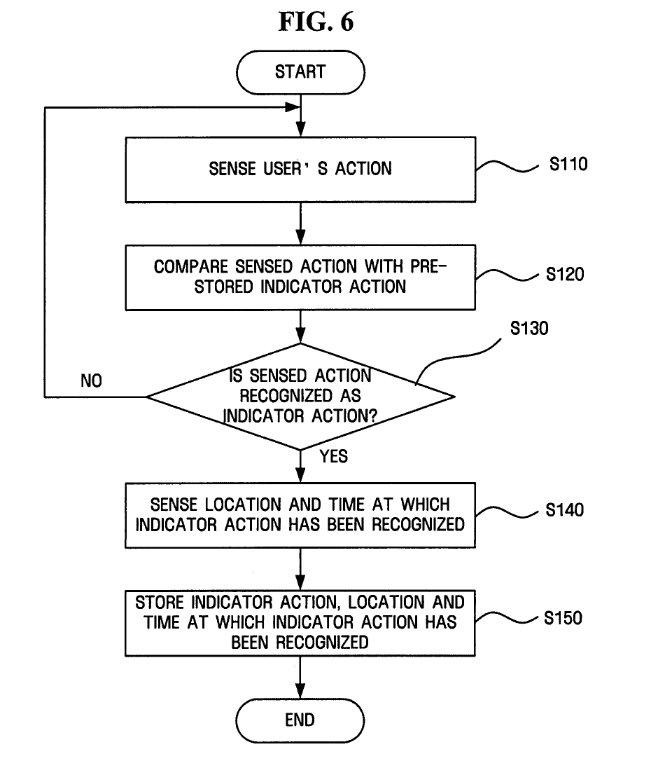

FIG. 6 illustrates a method of storing an action history of a user, according to an embodiment of the present invention.

As shown in FIG. 6, a method of storing the action history will be described. In operation S110, the user's actions may be sensed, e.g., by the action sensor 120, using a variety of sensors mounted on any part of the user's body. Here, examples of the sensors mounted on parts of the user's body include, without limitation, an inertial sensor, a pressure sensor, an electromyogram sensor and a heartbeat sensor.

In operation S120, the actions sensed by the various sensors may be compared, e.g., by the action-recognition unit 130, with predetermined indicator actions and the sensed action may be recognized as an indicator action according to a comparison result by the action-recognition unit 130.

The indicator action, in an embodiment of the present invention, may be an action that easily results in the loss of an item. Thus, the user's actions may be sensed, e.g., by the action sensor 120, and compared with pre-stored indicator actions by the action-recognition unit 130, for example, colliding, collapsing, dozing, grasping, sitting, reclining, standing, running, hurrying, and so on, and, based on the comparison result, the sensed action may be recognized as one of the indicator actions.

While the indicator action has been described in an embodiment as an action that easily results in the loss of an item, the invention is not limited thereto, and the indicator action may correspond to any user action that easily causes a particular result. Accordingly, one or more embodiments of the present invention may be applied to not only the tracking of lost items but also to the sensing of a user's action and the deducing of any particular result that may be caused by the sensed action.

If the sensed action is recognized as an indicator action by the action-recognition unit 130 in operation S130, a location where the indicator action has been recognized may be sensed, e.g., by the location sensor 110, and a time at which the indicator action has been recognized may also be sensed by the location sensor 110, in operation S140. Here, while a method has been described with regard to an embodiment in which the location sensor 110 senses both the location and the time at which the indicator action has been recognized, the invention is not limited thereto, and a functional component for sensing a time at which the indicator action has been recognized may be separately employed by different systems.

The action history of the user, including one or more indicator actions and the locations and times at which the indicator actions have been recognized, may be stored, e.g., by the action history storage unit 140, in operation S150.

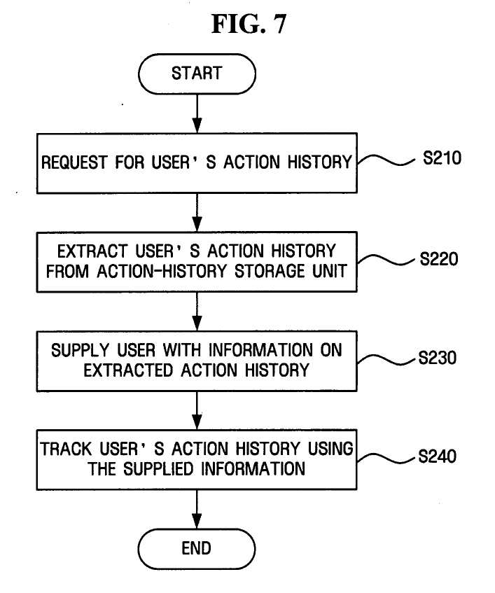

FIG. 7 illustrates a method of supplying a user with the stored action history, according to an embodiment of the present invention.

As shown in FIG. 7, when the user loses an item, the user may issue a request for an action history in operation S210. Here, for example, the user's request for the action history may be issued through a portable terminal having the information-supply unit 150 embedded therein, although embodiments of the present invention are not limited thereto.

If the user issues a request for the action history, stored action history information may be extracted, e.g., by the information supply unit 150 from the action-history storage unit 140, in operation S220, and the extracted action history information may be supplied to the user in operation S230, e.g., by the information supply unit 150 via the graphical user interface. In operation S230, the user may be supplied with the action history information not only via a graphical user interface, but also in text format, e.g., by the information-supply unit 150.

The user may identify the graphical user interface supplied from the information-supply unit 150, and may track the location and time at which the indicator action has been recognized, according to at least one of a sequence of time, and a reverse sequence thereof in operation S240.

As described above, when an event involving a user losing an item has occurred, the user may recall her action history including actions such as an indicator action, and a location and time at which the indicator action has been recognized, thereby specifying the location and time at which the item may have been lost, in order to discover the location of the item.

One or more embodiments of the present invention may have been described herein with reference to block diagrams or flowchart illustrations. It will be understood that each block of the flowchart illustrations, and combinations of blocks in the flowchart illustrations, may also be implemented with computer program instructions. These computer program instructions may be provided to a processor of a general purpose computer, special purpose computer, or other programmable data processing apparatus such that the instructions implement the operations specified in the flowchart block or blocks.

The computer program instructions may also be stored in a computer usable or computer-readable memory that can direct a computer or other programmable data processing apparatus to operate in a particular manner, such that the instructions implement the operation specified in the flowchart block or blocks. The computer program instructions may also be loaded into a computer or other programmable data processing apparatus to cause a series of operations to be performed on the computer or other programmable apparatus to produce a computer implemented process for implementing the operations specified in the flowchart block or blocks.

In addition, each block of the flowchart may represent a module, a segment, or a portion of code, which may comprise one or more executable instructions for implementing the specified logical functions. It should also be noted that in other implementations, the operations noted in the blocks may occur out of the order noted or in different configurations of hardware and software. For example, two blocks shown in succession may, in fact, be executed substantially concurrently, or the blocks may sometimes be executed in reverse order, depending on the operations involved.

Still further, the term “unit”, as used herein, may mean, but is not limited to, a software or hardware component, such as a Field Programmable Gate Array (FPGA) or an Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and units may be implemented such that they execute one or more computers in a communication system.

Thus, with this in mind, and in addition to the above described embodiments, embodiments of the present invention may also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

A system, method and medium tracking an action history of a user, according to one or more embodiments of the present invention may provide at least the following advantages.

An action history of user, including an indicator action recognized by an action-recognition unit and a location and time at which the indicator action has been recognized, may be stored so as to retrace movements along a movement track upon request, thereby encouraging memory recall for enhanced tracking of a lost item.

Since it may not be necessary to separately install a device for every item to be monitored to prevent items from being lost, user convenience and usability may be enhanced and costs required for preventing loss of items may be reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system for tracking an action history of a user, comprising:
a location sensor to sense a location of a user;
an action sensor to sense an action of the user;
an action-recognition unit to recognize the sensed action as a predetermined indicator action;
an action-history storage unit to store the sensed location and the recognized indicator action as the action history of the user; and
an information-supply unit to supply the user with the stored action history upon request.

2. The system of claim 1, wherein the location sensor senses the location using at least one of a GPS (Global Positioning System) and an indoor GPS.

3. The system of claim 1, wherein the action sensor senses the user's action using at least one of an inertial sensor, a pressure sensor, an electromyogram sensor and a pulse sensor.

4. The system of claim 1, wherein the action-recognition unit compares the sensed action with pre-stored indicator actions, and recognizes the sensed action as a predetermined indicator action according to the comparison result.

5. The system of claim 1, wherein the information-supply unit includes a display unit for displaying on a predetermined map at least one of the user's movement path, the indicator action, a time at which the indicator action has been recognized, and a location at which the indicator action has been recognized

6. The system of claim 5, wherein the user recalls the action history starting with a present time and ending with a time at which the indicator action has been recognized or starting with the time at which the indicator action has been recognized and ending with the present time.

7. The system of claim 1, wherein the predetermined indicator action includes at least one of colliding, collapsing, toppling, dozing, running, sitting, standing, and hurrying.

8. A method for tracking an action history of a user, the method comprising:
sensing a location of a user;
sensing an action of the user;
recognizing the sensed action as a predetermined indicator action;
storing the sensed location and the recognized indicator action as the action history of the user; and
supplying the user with the stored action history upon request.

9. The method of claim 8, wherein the indicator action includes at least one of colliding, collapsing, toppling, dozing, running, sitting, standing, and hurrying.

10. The method of claim 8, wherein the sensing of the user's action comprises sensing a user's inertial movement using an inertial sensor mounted on at least one of a wrist and a waist of the user.

11. The method of claim 8, wherein the sensing of the user's action comprises sensing a user's hand action using at least one of a pressure sensor and an electromyogram sensor mounted on a wrist of the user.

12. The method of claim 8, wherein the sensing of the user's action comprises sensing a heart rate of the user using a pulse sensor.

13. The method of claim 8, wherein the recognizing of the predetermined indicator action comprises:
comparing the sensed action with pre-stored indicator actions, and recognizing the sensed action as a predetermined indicator action according to the comparison result.

14. The method of claim 8, wherein the sensing of the user's location comprises sensing the location using at least one of a GPS (Global Positioning System) and an indoor GPS.

15. The method of claim 8, wherein the supplying of the information on the action history comprises displaying a user's movement path in which symbols corresponding to the indicator action are overlaid on a predetermined map.

16. The method of claim 15, wherein the supplying of the information on the action history comprises retracing the supplied action history starting with a present time and ending with a time at which the indicator action has been recognized.

17. The method of claim 15, wherein the supplying of the information on the action history comprises retracing the supplied action history starting with a time at which the indicator action has been recognized and ending with a present time.

18. At least one medium comprising computer readable code to control at least one processing element to implement the method of claim 8.

19. A method tracking actions of a user, the method comprising:
sensing an action of the user;
recognizing the sensed action as a predetermined indicator action;
storing the recognized indicator action along with a corresponding location and time as an action history of the user; and
providing the stored action history upon request.

20. At least one medium comprising computer readable code to control at least one processing element to implement the method of claim 19.

21. A system tracking actions of a user, the system comprising:
an action sensor to sense an action of the user;
an action-recognition unit to recognize the sensed action as a predetermined indicator action;
an action-history storage unit to store the recognized indicator action along with a corresponding location and time as an action history of the user; and
an information-supply unit to provide the stored action history upon request.
